(19) United States
(12) Patent Application Publication
(10) Pub. No.: US 2026/0043306 A1
(43) Pub. Date: Feb. 12, 2026

(54) METHOD TO CONTROL A WELL

(71) Applicant: ITALMATCH CHEMICALS GB LTD, Manchester (GB)

(72) Inventors: Callum Scullion, Aberdeen (GB); Patrick Collins, Aberdeen (GB)

(73) Assignee: ITALMATCH CHEMICALS GB LTD, Manchester (GB)

(21) Appl. No.: 19/124,493

(22) PCT Filed: Oct. 27, 2023
(86) PCT No.: PCT/GB2023/052811

§ 371 Date: Apr. 25, 2025

(30) Foreign Application Priority Data
Oct. 27, 2022 (GB) 2215923.0

(51) Int. Cl. E21B 33/138; E21B 33/12

(52) U.S. Cl. CPC E21B 33/138; E21B 33/1204

(57) ABSTRACT

A method of controlling a well comprising adding a scaling solution into a reservoir via the well which forms scale in pores or channels of the reservoir in order to inhibit fluid flow; then, deploying a fluid into the well to create a hydrostatic head extending for at least 50 m. In this way two independent barriers are provided to control the well. Intervention work may then be done on the well, involving removing the wellhead. Equipment can be deployed through the hydrostatic head without the requirement to set a plug.

### CROSS-REFERENCE TO RELATED APPLICATIONS

The present application is a National Phase Application of International Application No. PCT/GB2023/052811, filed Oct. 27, 2023, which claims the benefit of and priority to Application No. GB2215923.0, filed on Oct. 27, 2022, the disclosures of which are both incorporated herein by reference in their entirety.

### BACKGROUND

This invention relates to a method to control a well, especially a longstanding hydrocarbon well.

In order to intervene in a well it is necessary to control the natural well pressure to prevent escape of hydrocarbons to the environment or the uncontrolled loss of fluid into the reservoir. This is often accomplished by setting a plug barrier in the well using a drilling rig or wireline intervention tools. In some cases such as subsea wells, a rig is deployed to the site, and a wireline extended through topside apparatus, such as a Christmas tree on the top of the well, to set a plug within production tubing in the well. The Christmas tree—which previously controlled the well pressure, can then be removed and work performed on the well above the newly set plug.

However, the portion of the well below the plug remains inaccessible. Moreover, for longstanding wells, that is over 20 years old, the production tubing may be of poor quality or have deteriorated or deformed. Therefore, there is uncertainty whether a proper seal can be effected when a plug is set in this way. This also compromises the economics of deploying a rig, and associated cost, when the operation to install such a plug barrier may not be effective, and subsequent intervention anywhere in the well may not be possible.

### SUMMARY

An object of the present invention is to mitigate one or more problems associated with the prior art.

According to the present invention, there is provided a method of controlling a well comprising:
adding a scaling solution into a reservoir via the well which forms scale in pores or channels of the reservoir in order to inhibit fluid flow; then,
deploying a fluid into the well to create a hydrostatic head extending for at least 50 m.

Thus the well is then controlled by the scaling solution blocking pores/channels in the reservoir, and secondly by the hydrostatic head. This provides two independent barriers to the egress of hydrocarbons into the environment.

Topside apparatus on the well can then be safely removed to allow for well intervention.

The topside apparatus may be a wellhead, blow-out preventor (BOP), Christmas tree, well cap or any other device connected at or near the top of the well to control the well; especially a wellhead or Christmas tree.

Optionally, equipment may then be deployed into the well, optionally through the hydrostatic head fluid.

The hydrostatic head is defined in the usual way known to those skilled in the art, i.e. as a vertical height of a fluid column exerting a pressure at the base of the column.

The present applicant has previously described, in EP3387086 and EP3630910, methods of abandoning a well comprising adding a scaling solution followed by permanent cement plugs, in order to abandon a well or a zone of a well.

By contrast, the present invention relates primarily to well control and optional intervention.

In accordance with the present invention, the well can be controlled with a dual-barrier, and intervention can take place. Moreover, access to the well is not necessarily compromised by the presence of a plug. Furthermore, as the deployment of the scaling solution and hydrostatic head fluid can be done without a rig, the economics of intervention can be improved as the intervention rig can be deployed once the well is under control in accordance with the present invention. In particular the process can reduce the risk and consequent cost of not being able to set a plug.

Accordingly, the present invention provides a method of well intervention comprising
the method of controlling a well as described herein;
removing topside apparatus from the well;
deploying equipment into the well.

Various activities can optionally take place in the well. Equipment can be removed, optionally replaced. For example, the production tubing may be removed and optionally replaced. A valve can be removed, optionally replaced. In the case of abandonment, a barrier may be put in place, such as a plug. Plugs are ideally secured against casing in the well and so may be placed after removal of the production tubing.

The topside apparatus can be replaced onto the well. This may be the same topside apparatus as previously removed from the well, or some new equipment. For example, it may be desired to replace some old equipment with some new equipment, to improve reliability and/or to provide additional functionality.

For certain embodiments, the well may be perforated. This is typically in a different zone of the reservoir compared to the zone of the reservoir where the scale has been deployed. Fluids may be produced through the new perforations, or they may alternatively be used for injection of fluids.

In other embodiments, the methods of the invention may be used as a first stage in abandoning a well, or abandoning a zone of a well. For example, a permanent cement plug may be added.

A skilled person would not consider a hydrostatic head to be an effective barrier in a well which had previously produced, as fluid in the hydrostatic head would be expected to dissipate back into the reservoir through the pores or channels. However, the present invention prevents or minimises such as loss because of the formation of the scale. Thus whilst the formation of the scale and the hydrostatic head provide two independent barriers, there is some further synergy in that the scale formed maintains the hydrostatic head in place.

The scale may be formed as described in aforementioned prior disclosures U.S. Pat. No. 5,244,043, EP3387086 and EP3630910, the disclosures of which are incorporated herein by reference in their entirely.

The scaling solution may comprise a first scale precursor, a second scale precursor and surprisingly, given the intent to form scale, a scale inhibitor. This controls the reaction between the first and second scale precursor, and better optimises the area where scaling occurs.

A mixture comprising the first scale precursor and second scale precursor and an inhibitor are normally introduced via tubing in the well through an existing conduit. This may be directed through the topside equipment before removing it.

The first scale precursor may be a salt of a Group 1 metal or ammonium in which it provides the anionic species. Sodium or potassium or ammonium are preferred and ammonium is a particularly preferred cation. The counterion of the first scale precursor may be a sulphate, carbonate or bicarbonate; preferably sulphate.

As noted above, ammonium sulphate has surprisingly been found to be particularly effective.

For certain embodiments therefore, the first scale precursor is an ammonium sulphate brine.

The first precursor is a solution optionally containing from 10-30 wt % of the anionic species, such as sulphate, and preferably from 15-22 wt %; such that on application after further dilution with water and the other precursor fluids, the first scale precursor optionally contains 1-5 wt % of the anionic species, such as sulphate, preferably from 2.5 to 3.5 wt %.

The second scale precursor may be a salt of a Group 2 metal in which the Group 2 metal provides the cationic species. The Group 2 metal may be calcium, magnesium, strontium or barium; calcium is preferred because it is both more economical and less toxic. The counterion of the second inorganic salt may be an inorganic anion such as nitrate or halide anions especially chloride. For example, the salt may be selected from the group consisting of a calcium halide or nitrate.

For certain embodiments therefore, the second scale precursor is a calcium chloride brine.

The second precursor is a solution optionally containing between 5-15 wt % of the cationic species, such as calcium, and preferably 7-12 wt %; such that on application after further dilution with water and the other precursor fluids, the second scale precursor optionally contains 0.85 to 2.5 wt % of the cationic species, such as calcium, and preferably from 1.15 to 2.0 wt %.

The hydrostatic head extends for as far as is required to contain the well, in the theoretical absence of the scaling solution. In this way, it provides an independent second barrier for well control. It can therefore extend for more than 100 m or more than 200 m.

The fluid used to create the hydrostatic head is normally a water-based fluid. It may be simply water, such as sea water. However, including further salts increases the weight and therefore reduces the amount of fluid required. Any suitable non-toxic salt may be used such as sodium or calcium chloride, sodium or calcium bromide or sodium or potassium formate solutions with the salt concentration being adjusted to provide sufficient density to provide the desired hydrostatic head.

For certain embodiments, the head fluid may be a brine comprising one of the first or second scale precursors. In this way, whilst the primary function of the head fluid is to provide a hydrostatic head to contain the well (in the theoretical absence of the scaling solution), it can also function to top-up the scaling precursors used to inhibit flow through the pores or channels.

The scaling solution and/or the brine may contain additional components as appropriate for specific applications such as viscosity modifiers, flow improvers, surfactants, emulsifiers etc.

The scale inhibitor may also be selected from the group consisting of: a phosphonate, a carboxylic acid, a carboxylate, an acrylic acid, an acrylate, a carboxylic based sulphonate, a phosphonic acid, a sulfonate, a sulfonic acid, a maleic acid, a maleate, an aspartic acid, an aspartate, a polysaccharide, a polyvinyl and a phosphinocarboxylic acid salt, or a derivative, polymer, copolymer thereof, or a combination thereof.

In particular the scale inhibitor may be a phosphonate, acrylate, and carboxylate; or acids thereof.

For certain embodiments the scale inhibitor comprises a phosphonate.

For example, the scale inhibitor may be a polyphosphinocarboxylate polymer and/or a diethylenetriaminepentaacetic acid based phosphonate and/or a pentamethylenephosphonic acid.

The scale inhibitor may be Bellasol S50 ™ or Briquest™ or Dequest 2066A™. If necessary, it may be neutralised so that it's pH is in the range of 4.0 to 6.0 inclusive.

The scale inhibitor typically reduces the rate of reaction between the first and second scale precursors or between other components and/or substances of the scaling solution and a fluid in the reservoir or between components and/or substances of the scaling solution. It therefore reduces the rate of scale formation. If for example the mixture comprises sodium or ammonium sulphate and calcium chloride respectively, the scale inhibitor may reduce the rate of reaction between these two components and therefore the rate of production of calcium sulphate scale. The scale inhibitor typically does not prevent scale production, rather it slows reaction kinetics, that is the rate of reaction between components of the first and/or second precursors. It is this that allows the rate and, more importantly, the position of scale formation to be controlled in the method of the invention.

The scale inhibitor may substantially reduce the rate of scale formation for up to 24 hours, typically up to 12 hours and preferably from 4 to 8 hours after adding the scaling solution into the reservoir to form a scale. The scale inhibitor may substantially reduce the rate of scale formation for up to 12 hours, typically up to 6 hours and preferably from 1 to 2 hours after the step of adding the scaling solution into the reservoir to form a scale. After the step of adding the scaling solution into the reservoir to form a scale, the scale inhibitor may adsorb onto surfaces of the reservoir. Adsorption of the scale inhibitor reduces the amount of the scale inhibitor available. The amount of the scale inhibitor reduces and/or diminishes with an increase in the distance from the well. This may act to accelerate scaling and precipitation within the reservoir in these areas. As subsequent scale inhibitor enters the reservoir, an equilibrium between adsorbed scale inhibitor and free scale inhibitor is normally achieved. It may then be desirable to reduce the amount of inhibitor added to the well to take account of this and therefore allow scale to form closer to the well and/or well bore. The scale inhibitor may be added to the well as treated water.

The step of adding the scaling solution into the reservoir may continue until the injection pressure is close to or the same as the fracture pressure of the reservoir and/or no further solutions can be added. The step of adding the solutions into the reservoir may include injecting and/or pumping the solutions into the reservoir.

The concentration of scale inhibitor in the scaling solution may be from 0.1 wt % to 5 wt %.

Scale formation occurs in the reservoir even though there is a scale inhibitor present in the mixture. The scale may be any inorganic scale such as barium sulphate or calcium sulphate. The scale typically forms a deposit on surfaces of the reservoir. The scale is typically a solid that is not readily soluble, by for example an acid and/or a hydrocarbon.

Ideally the scale will have a solubility product (KSp) at ambient temperature (25° C.) of 1×10″5 and more preferably a KSP at ambient temperature (25° C.) of 1×10 6.

The scale formed in one embodiment is calcium sulphate. In this case, the first scale precursor will contain the sulphate anion. Preferably this is in the form of sodium or especially ammonium sulphate. The second precursor will contain the calcium cation. The calcium cation is preferably in the form of calcium chloride. The calcium chloride and sodium or ammonium sulphate can then react to form the scale. One of the key benefits of calcium sulphate in particular is that it is highly insoluble. Furthermore, it is thermodynamically very stable and, having formed within the well, the reaction cannot easily be reversed. As such, its formation can be considered to be permanent. A further advantage of calcium sulphate is that its solubility reduces as temperature is increased. Consequently, at the elevated temperatures present in the reservoir it enjoys even lower solubility than under ambient conditions. This may also assist in the permanent nature of the scale that is formed.

For certain embodiments, the steps of the method may be represented by the following chemical equation:

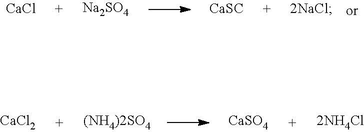

Gypsum is typically calcium sulphate dehydrate, that is CaSO₄-2H₂O. The calcium sulphate formed when the material is injected into the reservoir may be gypsum.

In an alternative embodiment, the scale is calcium carbonate. In this case, the first scale precursor will contain the carbonate anion or bicarbonate anion, and the second scale precursor will contain the calcium cation. The carbonate anion or bicarbonate anion are preferably in the form of sodium or ammonium carbonate or bicarbonate. Again, the calcium cation is preferably in the form of calcium chloride.

In the case of some scales, such as calcium sulphate, the rate and extent of scale formation increases with increasing temperature meaning that as the first and/or second precursor enters the reservoir its temperature will eventually reach that of the reservoir causing more scale to form and further reducing the effectiveness of the scale inhibitor.

The well may be a subsea well. The well may have produced for over ten or over twenty years.

The method may include a pre-treatment step of flushing the well, prior to adding the scaling solution.

The method may comprise the further steps of:
(i) stopping the introduction into the reservoir of the scaling solution and shutting in the well for 2-24 hours; and
(ii) introducing into the reservoir, via a well, a further scaling solution comprising a scale inhibitor, a first scale precursor and a second scale precursor, wherein the first and second scale precursors of the further scaling solution react together to form scale.

The scale inhibitor, the first scale precursor and the second scale precursor of the scaling solution may be the same as the scale inhibitor, the first scale precursor and the second scale precursor of the further scaling solution, respectively.

Steps (i) and (ii) may be repeated at least once.

The step (i) of stopping the introduction into the reservoir of the scaling solution may last for from 4 to 12 hours before step (ii).

The well may comprise tubing and the method may further include a step of displacing the scaling solution from the tubing, subsequent to adding the scaling solution and prior to step (i).

The well may have perforations therein, and the method may further include the step of at least partially blocking the perforations with a fluid such as or more of silicone, a vinyl silicone, a vinyl terminated silicone, polydimethylsiloxane, vinyl polydimethylsiloxane, a fumed silica, a silica flour and a siloxane.

According to a further aspect of the present invention, there is provided a method of controlling a well comprising:
adding a scaling solution into a reservoir via the well which forms scale in pores or channels of the reservoir in order to inhibit fluid flow; then,
stopping the introduction into the reservoir of the scaling solution and shutting in the well for 2-24 hours; and
introducing into the reservoir, via a well, a further scaling solution comprising a scale inhibitor, a first scale precursor and a second scale precursor, wherein the first and second scale precursors of the further scaling solution react together to form scale; then,
deploying a fluid into the well to create a hydrostatic head extending for at least 50 m;
wherein the scaling solution comprises a first scale precursor being ammonium sulphate, a second scale precursor comprising a soluble salt of a Group 2 metal and a phosphonate scale inhibitor;
wherein the scale inhibitor, the first scale precursor and the second scale precursor of the scaling solution are the same as the scale inhibitor, the first scale precursor and the second scale precursor of the further scaling solution, respectively.

### BRIEF DESCRIPTION OF THE DRAWINGS

Embodiments of the present invention will now be described, by way of example only, with reference to the accompanying figures, in which:

FIG. 1 is a sectional view of a well suitable for use with embodiments of the present invention;

FIG. 2 is a sectional view of the FIG. 1 well, which has undergone a first scaling step of a method in accordance with the present invention;

FIG. 3 is a sectional view of the FIG. 1 well, which has undergone two steps of a method in accordance with the present invention;

FIG. 4 is a sectional view of the FIG. 1 well, illustrating one embodiment of the invention, in which the topside apparatus has been replaced;

FIG. 5 is a sectional view of the FIG. 1 well, illustrating a second embodiment of the invention, in which the topside apparatus has been removed and a plug inserted into the well;

FIG. 6 is a sectional view of the FIG. 1 well, illustrating a third embodiment of the invention, in which the topside apparatus has been removed and tubing is to be removed from the well;

FIG. 7 is a sectional view of the FIG. 1 well, illustrating a fourth embodiment of the invention, in which the well has been re-perforated;

FIG. 8 is a sectional view of the FIG. 7 well, in an embodiment where fluid is produced from the perforations created by the re-perforation;

FIG. 9 is a sectional view of the FIG. 7 well, in an embodiment where fluid is injected into the perforations created by the re-perforation;

FIG. 10 a schematic of a core flood apparatus;

FIG. 11 is a plot of differential pressure versus pore volume for a first core flood experiment;

FIG. 12 is a plot of differential pressure versus pore volume for a second core flood experiment;

FIG. 13 is a plot of effective differential pressure versus pore volume for a third core flood experiment; and

FIG. 14 is a plot of differential pressure versus pore volume for a specific part of the third core flood experiment.

### DETAILED DESCRIPTION

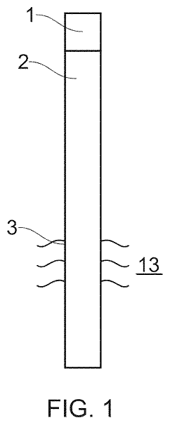

FIG. 1 shows a schematic view of a well 2 with a topside assembly 1 and perforations 3 into a reservoir 13. The well 2 is typically a longstanding well which has produced hydrocarbons from the reservoir 13 for many years. The topside assembly 1 may include a BOP, a wellhead, or a so-called “Christmas Tree” including valves etc, but in any case functions to control the well.

For various reasons, it may be desired to intervene in the well. For example, to replace the topside assembly, insert a plug, remove production tubing or some other activity.

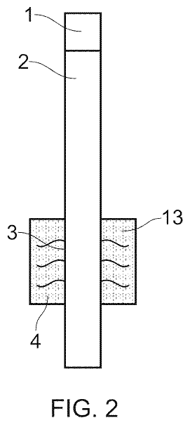

A first stage of an embodiment in accordance with the present invention is shown in FIG. 2 where a scaling solution is deployed into the well 2, and enters the pores/perforations 3 in the reservoir 13 where it forms mineral scale 4 to block hydrocarbon flow therefrom into the well.

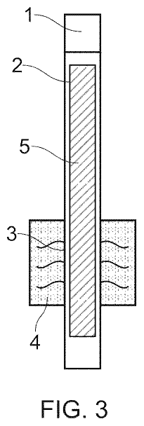

A second stage of the embodiment is shown in FIG. 3, where a fluid 5 forms a hydrostatic head extending for at least 50 m. Thus, even without the mineral scale 4, the pressure created by the hydrostatic head overcomes any remaining well pressure and controls the well itself and prevents leakage of hydrocarbons to the environment. In this way, two independent barriers are formed to resist leakage of hydrocarbons to the environment—the scale 4 and the hydrostatic head 5.

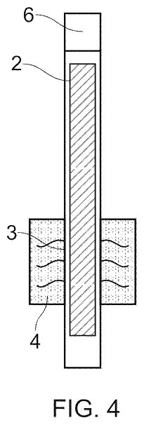

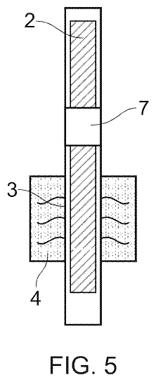

After the well has been controlled in this way, a variety of interventions can be made. In FIG. 4, a new topside apparatus 6, such as a repaired_wellhead/Christmas tree/valve/cap has been added to the well in place of the topside apparatus 1. In FIG. 5 the topside apparatus 1 has been removed, and a device 7 has been added to the well, such as a mechanical plug, a cement plug, a valve or other equipment. Notably, the device 7 may be deployed through the fluid of the hydrostatic head (in contrast to solid barriers). At no point during this are any barriers required to be removed after any subsequent well operation.

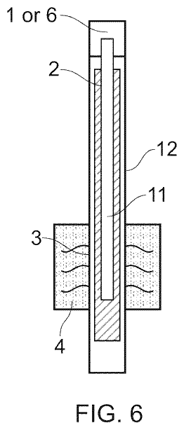

FIG. 6 illustrates production tubing 11 which may also be removed from the well, for example before abandoning the well. Optionally, a new topside apparatus 6 may also be added to the well, as described above. Oftentimes, for longstanding wells, it is more difficult to reliably secure a barrier or plug within the production tubing. Accordingly it is preferred to remove the production tubing 11 and set a plug more reliably against the outside casing 12 of the well. An embodiment of the present invention allows for control of the well whilst the production tubing is being removed. Once again, at no point during this procedure are any barriers required to be removed.

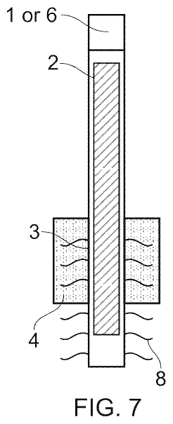

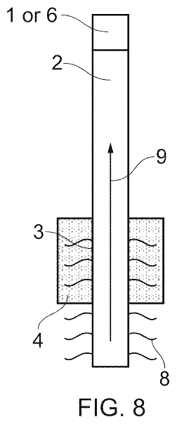

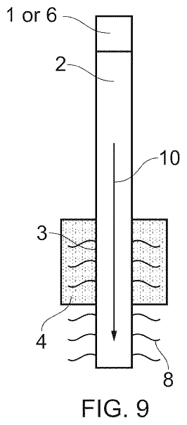

In an alternative embodiment, a different zone of the well may be perforated 8, with a view to producing hydrocarbons 9 from this zone, as illustrated in FIGS. 7 and 8. For such embodiments, the hydrostatic head may be removed before perforating into the new zone and optionally a topside apparatus is added before perforating again, to control the well. Fluid may be produced from via the new perforations. Alternatively, as per FIG. 9, the newly created perforations 8 may be used to inject fluid into the reservoir, in order to stimulate the reservoir to produce elsewhere, or sequestrate fluids. Thus various gases or liquids may be added, such as water, steam, hydrocarbons with water, previously produced fluids, nitrogen and carbon dioxide. All of this can be carried out without the requirement to remove the hydrostatic barrier.

In the foregoing embodiment, calcium chloride, sodium sulphate and a scale inhibitor may be injected into channels and pores 3 in the reservoir 13 to form calcium sulphate scale 14. A silicone 18 may be added into the well 10 in particular to block the perforations in the well 10.

In one embodiment, the scale inhibitor 4 is dosed or spiked into water at a concentration of from 0.5 to 2.0 wt percent. This is combined with a sodium sulphate brine containing 139 g/ltr sodium sulphate giving a concentration of from 0.5 to 1.0 mol/L thus forming a saturated solution of sodium sulphate; and a saturated solution of calcium chloride containing 745 g/ltr calcium chloride is added having a concentration of from 0.8 to 1.2 mol/L calcium ions.

The whole mixture of brines, scale inhibitor and water is then injected into the well at a rate set such that the time taken from point of mixing to entry into the reservoir is less than the time taken for appreciable scale to form. They may be injected through the topside apparatus via coiled tubing or an existing conduit, for example.

In an alternative embodiment, a scale inhibitor 4 is dosed/spiked into the stream of water at a concentration of 0.1-2.0 wt %. The sulphate brine may comprise a saturated solution of ammonium sulphate brine containing 239 g/ltr ammonium sulphate such that a concentration of from 0.5 to 1.0 mol/L of sulphate ions is created in the water. And the calcium brine may contain 299 g/ltr calcium chloride brine 5 such that a concentration of from 0.8 to 1.2 mol/L calcium ions is created in the water.

The mixture of brines, scale inhibitor and water is then injected into the well in a similar manner.

The rate and therefore the location of scale formation within the reservoir can be controlled by making adjustments to the scale inhibitor concentration, the molar concentrations of either calcium or sulphate ions or the overall pump rate.

The method may also include injecting into the reservoir a dilute solution of an acid such as hydrochloric acid, formic acid, acetic acid and/or citric acid. The dilute solution of acid is at a concentration of from 0.25 to 5%. The dilute solution of an acid is injected into the reservoir prior, sometimes just prior, to scale inhibitor treated scaling waters. The subsequent scale inhibitor treated scaling waters mix with the dilute solution of an acid and on contact therewith this lowers the pH of the scale inhibitor treated scaling waters thereby rendering the scale inhibitor inactive and accelerating the scaling process.

Experiments were used to determine the time for the formation of scale using different sulphate salts as the first scale precursor and with the addition of different scale inhibitors.

Initially, the experiments were carried out using sodium sulphate and calcium chloride as the scale precursors, with either Bellasol S50™, a polyphosphinocarboxylate polymer scale inhibitor, or Briquest 543-45AS™, a commercially available salt of diethylenetriaminepentamethylene phosphonic acid (DTPMP). It was then discovered that using ammonium sulphate instead of the sodium scale may be advantageous for offshore applications and, consequently, further experiments were performed using ammonium sulphate and calcium chloride as scale precursors, with Dequest 2066A™ as the scale inhibitor.

Experiments using sodium sulphate:

The experiments were repeated at various Bellasol S50™ and Briquest 543-45AS™ inhibitor concentrations and at a pH of 7 and 4 respectively. A plastic cup was placed onto of a white sheet of paper with a black cross drawn on it, allowing the formation of calcium sulphate to be evaluated by the disappearance of the cross. 10 ml of the CaCl₂ solution and 10 ml of Na₂SO₄/inhibitor solution were measured and placed into the plastic cup. As soon as the brines were mixed together a timer was started.

Photos were taken every 30 minutes until the cross was no longer visible. It was however possible to observe a clear development in the formation of scale. In a pre-scaled cup the cross was completely visible. During the progression of scale formation, there was a reduction in visibility of the cross due to low levels of scale formation. A completely hidden cross indicated that the inhibitor had become completely ineffective and scale had fully formed. After 24 hours, the solution was filtered and the precipitate was weighed to determine the mass of calcium sulphate that had formed.

Table 1a below shows inhibition times, that is how long the formation of scale is inhibited using various concentrations of Bellasol S50™ and Briquest 543-45AS™.

Concentrations of scale precursors in tables 1a and 1b are given in moles per litre (mol/L) sometimes abbreviated as ‘M’.

TABLE 1a
Blank

| | | | Low level | | | |
|---|---|---|---|---|---|---|
| | | | Calcium | Full | Mass of | Mass of |
| | | | sulphate | Scale | precipitate | precipitate |
| Inhibitor | Volume | Volume | Formation | Formation | after 24 | after 24 |
| Concentration | Na₂SO₄ | CaCl₂ | Time | Time | hours | hours |
| (ppm) | (ml) | (ml) | (mins) | (mins) | (g/L) | (g) |
| 0 | 10 | 10 | — | 0 | 55.0 | 1.1 |

Bellasol S50 ™

| | | | Low level | | Mass of | |
|---|---|---|---|---|---|---|
| | | | Calcium | Full | precipitate | Mass of |
| | | | sulphate | Scale | after 24 | precipitate |
| Inhibitor | Conc. | Conc. | Formation | Formation | hours (g | after 24 |
| Concentration | Na₂SO₄ | CaCl₂ | Time | Time | per litre | hours |
| (ppm) | (mol/L) | (mol/L) | (mins) | (hrs) | fluid) | (g) |
| 5,000 | 1.0 | 1.0 | 30 | 24 | 42.5 | 0.85 |
| 25,000 | 1.0 | 1.0 | 90 | 24 | 40.5 | 0.81 |
| 50,000 | 1.0 | 1.0 | 120 | 24 | 41.0 | 0.82 |
| 75,000 | 1.0 | 1.0 | 180 | 24 | 41.5 | 0.83 |
| 100,000 | 1.0 | 1.0 | 240 | 24 | 44.5 | 0.89 |

Briquest 543-45AS ™

| | | | Low level | | Mass of | |
|---|---|---|---|---|---|---|
| | | | Calcium | Full | precipitate | Mass of |
| | | | sulphate | Scale | after 24 | precipitate |
| Inhibitor | Conc. | Conc. | Formation | Formation | hours (g | after 24 |
| Concentration | Na₂SO₄ | CaCL₂ | Time | Time | per litre | hours |
| (ppm) | (mol/L) | (mol/L) | (mins) | (mins) | fluid) | (g) |
| 5,000 | 1.000 | 1.000 | 30 | — | 28.5 | 0.57 |
| 10,000 | 0.739 | 1.06 | 40 | — | 50 | — |
| 25,000 | 1.000 | 1.000 | 90 | — | 16.0 | 0.32 |
| 50,000 | 1.000 | 1.000 | 720 | — | 12.5 | 0.25 |
| 100,000 | 1.000 | 1.000 | 2880 | — | 11 | 0.22 |

TABLE 1b

| CaCl2 | Na2SO4 | | | Scaling | Weight |
|---|---|---|---|---|---|
| (mol/L) | (mol/L) | Inhibitor (%) | Hazying (mins) | (mins) | (g/100 ml) |
| 1.06 | 0.739 | 0 | 0 | 0 | 6.19 |
| 1.06 | 0.739 | 0.75 | 12 | 15 | 0.5 |

A concentration range of inhibitor from 5000 ppm (0.5%) to 100,000 ppm (10%) was used throughout.

100 ml of each inhibitor concentration was prepared. Appropriate volumes of inhibitor were measured into a volumetric flask and made up to 100 ml with Na₂SO₄. Inhibitors were only added to the Na₂SO₄ solution due to both being insoluble in CaCl₂.

The pH of each of inhibitor stock solutions was altered accordingly, see Table 2 below.

TABLE 2

| Inhibitor (ppm) | Buffer solution | pH Required |
|---|---|---|
| Bellasol S50 ™ | NaOH | 7 |
| Briquest 543-45AS ™ | NaOH | 4 |
| Dequest 2066A ™ | NaOH | 4 |

Table 1a shows that when no inhibitor is applied to the Na₂SO₄ brine, and the brine is then mixed with CaCl₂, the solution becomes fully scaled instantly. When either inhibitor is added to the Na₂SO₄ brine, the formation of calcium sulphate is initially postponed. When the Bellasol S50™ is added, scale production is in two stages. Stage one involves the inhibitor retarding the growth, but not being able to completely block the development of, the crystals. This is illustrated by the formation of low levels of calcium sulphate. As time progresses stage two involves the inhibitor becoming less effective and becoming consumed in the growth of the crystal lattice. This is represented by a change from the large crystals into smaller, more stable crystals of calcium sulphate.

It was noted that, in the examples where calcium chloride and sodium sulphate were equimolar, the Briquest 543-45AS™ inhibitor never allowed the final crystal structure of calcium sulphate to be achieved and only allowed low levels of calcium sulphate to be formed. This indicates that the inhibitor could have been irreversibly adsorbed at the active growth sites of the calcium sulphate scale crystals, resulting in complete blockage, halting the production of the smaller more stable crystals of calcium sulphate. Use of a reduced concentration of sodium sulphate and a slightly increased concentration of calcium chloride resulted in a large gain in scale precipitation, to levels above those seen for Bellasol S50™.

Table Ta shows that both inhibitors postponed the formation of calcium sulphate for different lengths of time dependent on their concentration. A general trend was that as the concentration was increased, the time taken for the calcium sulphate scale to form also increased. The Bellasol S50™ inhibitor prevented the growth of calcium sulphate from 30 minutes to 240 minutes whilst the Briquest 543-45AS™ inhibitor could inhibit the growth from 30 minutes to 48 hours, although full scaling was never achieved.

The mass of calcium sulphate scale produced after 24 hours using both inhibitors is shown in table Ta. When compared to the blank sample it was highlighted that the Bellasol S50™ inhibitor produced a comparable mass of precipitate. This is compared to the equimolar brine and Briquest 543-45AS™ inhibitor tests, which produced a considerably lower mass (around 75% less) compared to the blank sample. However, using a lower ratio of sodium sulphate to calcium sulphate greatly increased the scale produced for Briquest 543-45AS™ Even so the quantity of scale produced in the inhibited system even after 24 hours was between 5 and 7 g/ltr compared to the blank where a quantity in excess of 60 g/ltr of scale was formed.

It was shown that the formation of calcium sulphate scale, from solutions of calcium chloride and sodium sulphate, can be controlled between 30 minutes and 48 hours using different scale inhibitors and adjusting the concentration of the inhibitors and the pH.

A number of laboratory tests have been conducted to investigate the method of controlling a well. A widely accepted technique to determine the effect on permeability of injecting fluids into an oil-bearing reservoir is to conduct core flood experiments. A piece of reservoir core or sandstone of similar permeability to the reservoir is cut to provide a core—a cylinder typically 2.54 cm (one inch) in diameter and between 7.62 to 15.24 (three to six inches) long. This core is mounted in a core flood holder such that fluid can be pumped through the core. Typically fluid is pumped through the core at a steady flow rate, typically using a syringe pump. The pressure differential across the core is measured and this is directly proportional to the permeability of the core. If the pressure differential decreases, permeability is enhanced and the core is stimulated. Conversely if the pressure differential increases, permeability is diminished and the core is damaged.

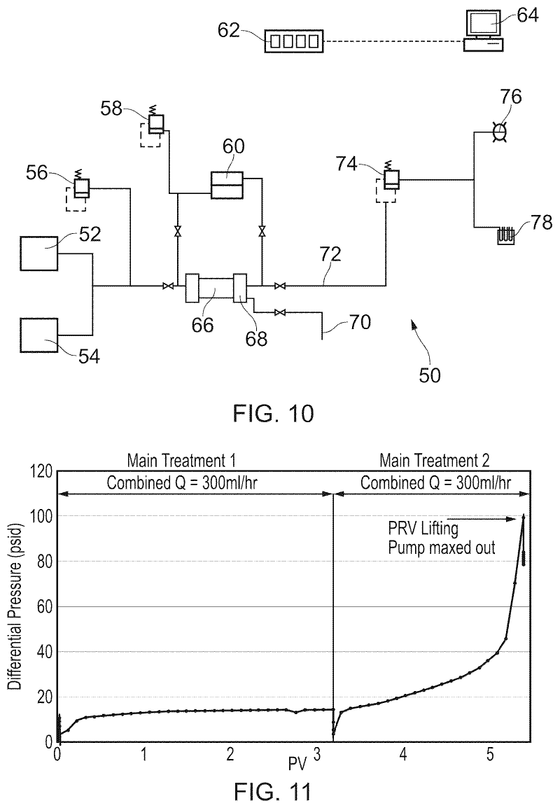

Fluid that has passed through the core was collected and analysed. FIG. 10 shows a schematic of a typical core flood apparatus.

The core flood apparatus (50) shown in FIG. 10 has two pumps, pump A (52) and pump B (54). Pump A (52) pumps a calcium brine solution; pump B (54) pumps an inhibitor in sulphate solution (/SI). The apparatus (50) has a bleed line and valve (56), pressure relief valve (58), pressure transducer (60), display readout (62) and computer (64). A core sample (not shown) is held in the core holder (66) that has twin port plates for face and line cleaning (68). One of the twin port plates for face and line cleaning (68) has a clean/back flush line (70) attached. The outlet line (72) is attached to a flow regulating valve (74) and then a UV analyser (76) and fraction collector (78).

The following procedure was adopted. The following solutions were prepared: a solution containing 21,000 mg/ltr of calcium by dissolving calcium chloride powder in water to produce a calcium brine; and a solution containing 35,500 mg/ltr of sulphate by dissolving sodium sulphate powder in water to produce a sulphate brine. A quantity of Briquest 543-45AS™, a commercially available salt of diethylenetriaminepentamethylene phosphonic acid (DTPMP), a scale inhibitor, was added to the sulphate brine to achieve a concentration of 5,000 mg/ltr of Briquest 543-45AS™. A core of Berea sandstone was cut and placed into the core holder apparatus. The available pore volume of the core was estimated to be 14 ml. A volume of the sulphate brine containing 5000 mg/ltr of scale inhibitor, equivalent to one pore volume, was introduced into the core and the scale inhibitor adsorbed on the surface. This was followed by three pore volumes of prepared calcium brine mixed with scale inhibitor containing sulphate brine. Pumping was stopped and the mixture was left in the core for a period of five hours, during which time the protection afforded by the inhibitor would have been lost and any scale formed would have precipitated within the core. During this time a pressure differential across the core was determine at 69 kPa (10 psi). After five hours flow was recommenced. No change in differential pressure was initially observed and this was as expected since only 0.7 g scale, equivalent to 3% of the pore volume, was estimated to have precipitated. However, once pumping recommenced the differential pressure across the core increased rapidly such that after five pore volumes the pressure exceeded 690 kPa (100 psi). FIG. 11 is a plot of differential pressure versus pore volume (PV) for the core flood. During the initial treatment a differential pressure of about 90 kPa (13 psi) was needed to achieve a flow rate of 300 ml/hour or 21 pore volumes (PV's) and there was little evidence of any damage to the core. However, after the core was shut in for five hours and flow restarted, differential pressure build-up started to occur almost immediately and within 2PV's from restarting the differential pressure exceeded 690 kPa (100 psi), activating the pressure relief valve in the equipment. This equates to a reduction in permeability of over eighty percent.

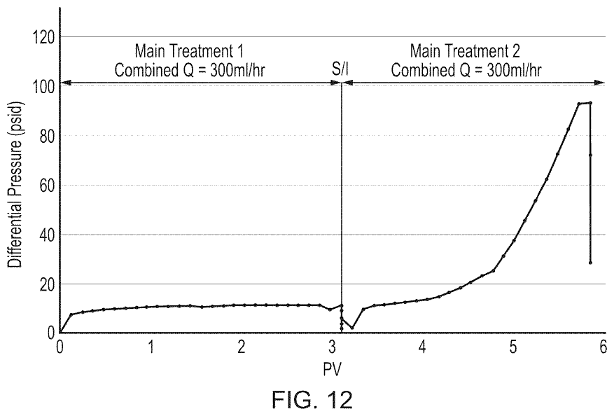

This was surprising and unexpected and so the test was repeated with a different core. The results are shown in FIG. 12. The results were very similar to the previous core flood experiment with differential pressure exceeding 690 kPa (100 psi). The rapid reduction in permeability was surprising and it was much more rapid and complete than was expected considering only five pore volumes of fluid had been injected, and by calculation only fifteen percent of the total pore volume is occupied by scale.

TABLE 3a

| | | | | Low level | |
|---|---|---|---|---|---|
| Salt used | Dequest | Conc. | | Calcium | Mass of |
| as first | 2066A ™ | Na₂SO₄ | | sulphate | precipitate |
| scale | Inhibitor | or (NH₄)₂SO₄ | Conc. | Formation | after 24 |
| precursor | Conc. (ppm) | (M) | CaCl₂ (M) | Time (mins) | hours (g) |
| Sodium | 10,000 | 0.739 | 1.06 | 40 | 50 |
| Ammonium | 10,000 | 0.739 | 1.06 | >180 | — |
| Ammonium | 5,000 | 0.739 | 1.06 | 33 | 60 |
| Ammonium | 2,500 | 0.739 | 1.06 | 15 | — |

TABLE 3b

| | | | | Low level | Mass of |
|---|---|---|---|---|---|
| | Dequest | | | Calcium | precipitate |
| Type | 2066A ™ | Conc. | Conc. | sulphate | after 24 |
| of water | Inhibitor | (NH₄)₂SO₄ | CaCl₂ | Formation | hours |
| used | Conc. (ppm) | (M) | (M) | Time (mins) | (g) |
| Fresh | 2,500 | 2.22 | 2.69 | 30 | 20-30 |
| Sea | 2,500 | 2.22 | 2.69 | 15 | — |
| Sea | 3,000 | 2.22 | 2.69 | 30 | 20-30 |

### Experiments Involving Ammonium Sulphate:

Further experiments were carried out using ammonium sulphate instead of sodium sulphate as the first scale precursor with an aim to replicate the scaling time observed when using the sodium salt. As before, calcium chloride was used the second scale precursor. Dequest 2066A™, a commercially available salt of diethylenetriaminepentamethylene phosphonic acid (DTPMP), was used as the scale inhibitor. The scale inhibitor was modified to have pH of 4 as shown in Table 2.

As before, the apparatus used comprised a plastic cup placed onto a white sheet of paper with a black cross drawn on it, allowing the formation of calcium sulphate to be evaluated by the disappearance of the cross. 50 ml of the calcium chloride solution and 50 ml of the solution comprising ammonium sulphate and the Dequest 2066A scale inhibitor were measured and placed into the plastic cup. The scale formation process was observed over a period of 24 hours. Table 3a shows how the concentration of Dequest 2066A affects the resulting mass of the precipitate formed after 24 hours. It was found that scale formation was more easily inhibited when using ammonium sulphate compared to sodium sulphate. Specifically, the amount of the scale inhibitor required to inhibit the reaction of ammonium sulphate with calcium chloride, and the resulting scale formation, is half of the amount of the scale inhibitor required when using sodium sulphate.

An advantage of using ammonium sulphate is that it is more soluble compared with sodium sulphate, meaning that higher concentrations of sulphate can be made available. Concentrated brines can be brought to an offshore site and diluted back with seawater before being injected down a well, reducing the total volume of fluids required to be shipped offshore. In order to test this approach, the experiment was repeated again, using more concentrated solutions of the scale precursors. The new formulation comprised a 29.3% w/v ammonium sulphate solution and 29.9% w/v calcium chloride solution. Dequest 2066A™ scale inhibitor was provided as a separate solution rather than being included in the sulphate solution.

The concentrates were spiked into water in the following order: scale inhibitor, ammonium sulphate, calcium chloride. In offshore applications, the introduction of the scale inhibitor before the scale precursors is preferred, as it prevents scaling due to interactions between sulphate ions in the scale precursor solution and the ions already present in seawater. In the first trial the concentrates were spiked into fresh water to monitor the scale formation time without the ion interferences of seawater. In the second trial fresh water was substituted with seawater.

During each trial the relative composition of the final mixture was 1 part concentrate to 2 parts water per solution, meaning 1 part concentrate to 6 parts total volume of the mixture. As a consequence, the concentrations of the scale precursors reduced by a sixth, and that of the scale inhibitor decreased by half, compared with the previous experiments. Table 3b shows the resulting mass of the precipitate formed after 24 hours, for both trials, that is using fresh water and seawater, the latter with different concentrations of the Dequest 2066A™ scale inhibitor.

It was found that the new formulation using more concentrated scale precursor solutions leads to a substantially the same scale formation time as the initial formulation using the less concentrated solutions, while requiring lower concentrations of the scale inhibitor.

Finally, a core flood experiment was performed to investigate the new formulation in the method of abandoning a zone or a well including the stopping step. The experiment was carried out using the apparatus as in the previous core flood experiments shown in FIG. 10. To simplify the pumping procedure the concentrate solutions were pre-blended such that the volume pumped through pump A (52) comprised 66.0% v/v filtered seawater, 33.4% v/v ammonium sulphate solution and 0.6% v/v pH-modified Dequest 2066A™ scale inhibitor solution, and the volume pumped through pump B (54) comprised 66.6% v/v filtered seawater and 33.4% v/v calcium chloride solution. The fluids were pumped at equal rates through a core sample.

The pressure differential across the core measured during the experiment is shown in FIGS. 7 and 8. In both figures the pressure is shown as a function of the pore volume of the fluids pumped through the core. One pore volume is defined as the volume of fluid required to fill the pores in the core. For the core used in the experiment one volume corresponded to 18 ml of fluid.

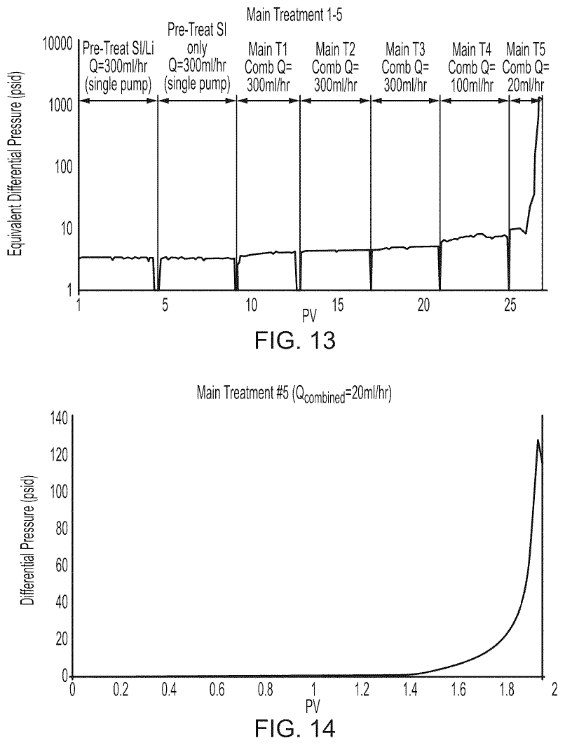

The first two sections in FIG. 13 represent pre-flush stages, therefore it was expected that no increase in pressure would be observed. In the first stage of the main treatment (Main T 1), that is the introduction of the mixture of the scale inhibitor and scale precursors, a slight increase in pressure was observed but not enough to block the core. The pumping was then stopped, the core was shut in to allow the solution to form nucleation sites, and the pumping was restarted. After pumping approximately 4 pore volumes of the mixture, no significant increase in pressure was observed.

Consequently, the stopping and restarting steps were repeated until such increase was noted. As shown in FIG. 13, during the fifth repetition of the main treatment (Main T 5) the pressure rose steeply reaching a maximum indicative of the complete blockage of the core.

As the flow rate was gradually reduced over the final two sections of the main treatment (Main T 4 and Main T 5), the y-axis in FIG. 13 shows the equivalent differential pressure instead of the actual differential pressure. As such, the equivalent pressure of 6900 kPa (1000 psi) corresponds to the actual differential pressure of 827 kPa (120 psi), which was the maximum allowable pressure before the pressure relief valve (58) of the equipment opened.

FIG. 14 shows the actual differential pressure change as a function of the injected pore volume for the final section (Main T 5) only. The initial value of the pore volume is set to 0 PV in order to clearly show at what stage during the final section the core began to block significantly. The steep rise in pressure begins approximately at 1.5 PV as measured from the beginning of the final section.

While in this experiment the scale formation sufficient to fully block the core required five repetitions of the main treatment, this would not be necessary under other conditions (including higher temperature, different pump rates, longer residence times, and/or larger/different volume of rock).

It follows from the above experiments that the new formulation with ammonium sulphate used as one of the scale precursors provides an effective method of controlling a well, with comparable scale formation time and reduced amount of scale inhibitor required, even compared with the initial formulation using sodium sulphate. Therefore, this formulation provides an advantage over the initial formulation for offshore applications as taking concentrated solutions of the scale precursors to site, diluting them back with seawater, adding a scale inhibitor to the diluted brines and mixing in line or just before pumping the fluids into the reservoir is a more practical approach than supplying the scaling solution ready to go to the site, owing to the large volumes of fluid required in the latter case. A barrier to flow can therefore be introduced by the simple means of mixing fluids on site and pumping them directly into the reservoir.

An example treatment composition for offshore applications may include 66.3% v/v filtered injection quality seawater, 16.7% v/v ammonium sulphate solution, 16.7% v/v calcium chloride solution and 0.3% v/v pH-modified scale inhibitor solution (shown in bold in Table 3b). The exact dose rates during application of the method of abandoning a zone or a well in a reservoir may vary depending on a range of factors such as, for example, the tubing volume or maximum pump rate. These variables will dictate the length of time it takes for the fluid to reach the reservoir, and therefore how long a delay is required to onset of scaling.

Modifications and improvements can be incorporated herein without departing from the scope of the invention.

1. A method of controlling a well, the method comprising:
adding a scaling solution into a reservoir via the well which forms scale in pores or channels of the reservoir in order to inhibit fluid flow; then,
deploying a fluid into the well to create a hydrostatic head extending for at least 50 m.

2. A method as claimed in claim 1, wherein the well is connected to topside apparatus, and the method further comprises removing the topside apparatus from connection to the well after the scaling solution has been added, and after deploying the fluid to create the hydrostatic head.

3. A method as claimed in claim 2, wherein the topside apparatus comprises at least one of a wellhead, blow-out preventor (BOP), Christmas tree and well cap.

4. A method of well intervention, comprising the method as claimed in claim 2, and running equipment into the well.

5. A method as claimed in claim 4, wherein the equipment is run into the well through the hydrostatic head.

6. A method as claimed in claim 4, wherein the equipment comprises a barrier, a plug and/or a valve.

7. A method as claimed in claim 2, wherein the well has production tubing therein, the production tubing is removed from the well, and a plug is set against casing in the well.

8. (canceled)

9. A method as claimed in claim 2, including perforating the well into a portion of the geological formation spaced from the reservoir.

10. A method as claimed in claim 9, wherein the portion of geological formation includes a second reservoir from which fluids are produced.

11. A method as claimed in claim 9, wherein the portion of geological formation includes a porous formation into which fluids are injected.

12. (canceled)

13. A method as claimed in claim 1, wherein the scaling solution comprises a first scale precursor, a second scale precursor and a scale inhibitor.

14. A method as claimed in claim 13 wherein the first scale precursor comprises a sulphate salt of sodium, or ammonium.

15. (canceled)

16. A method as claimed in claim 13, wherein the second scale precursor is a salt of calcium, magnesium, strontium or barium.

17. (canceled)

18. A method as claimed in claim 13, wherein the scale inhibitor comprises a phosphonate, acrylate, and carboxylate; or acids thereof.

19. A method as claimed in claim 18 wherein the scale inhibitor comprises a phosphonate.

20. A method as claimed in claim 1, comprising the further steps of:
(i) stopping the introduction into the reservoir of the scaling solution and shutting in the well for 2-24 hours; and
(ii) introducing into the reservoir, via a well, a further scaling solution comprising a scale inhibitor, a first scale precursor and a second scale precursor, wherein the first and second scale precursors of the further scaling solution react together to form scale.

21. A method as claimed in claim 20, wherein the scale inhibitor, the first scale precursor and the second scale precursor of the scaling solution are the same as the scale inhibitor, the first scale precursor and the second scale precursor of the further scaling solution, respectively.

22. (canceled)

23. (canceled)

24. A method as claimed in claim 21, wherein the well comprises tubing, and the method further comprises a step of displacing the scaling solution from the tubing, subsequent to adding scaling solution and prior to step (i).

25. (canceled)

26. A method as claimed in claim 1, wherein the hydrostatic head extends for at least 200 m.

27. (canceled)

28. A method as claimed in claim 1, wherein the well is then abandoned.
